(19) United States
(12) Patent Application Publication
(10) Pub. No.: US 2026/0031614 A1
(43) Pub. Date: Jan. 29, 2026

(54) POWER SUPPLY CIRCUIT AND RANGING DEVICE

(71) Applicant: SHENZHEN MILESEEY TECHNOLOGY CO., LTD., SHENZHEN (CN)

(72) Inventors: Long LUO, Shenzhen (CN); Zhi CHOU, Shenzhen (CN)

(21) Appl. No.: 18/814,586

(22) Filed: Aug. 26, 2024

(30) Foreign Application Priority Data
Jul. 25, 2024 (CN) 2024217846454

(51) Int. Cl. H02J 1/08; G01C 3/02; H02J 7/00

(52) U.S. Cl. CPC H02J 1/084; G01C 3/02; H02J 7/0068

(57) ABSTRACT

A power supply circuit and a ranging device, the power supply circuit includes multiple power supply units, multiple voltage protection modules and a power supply switching module, each voltage protection module is connected to each power supply unit in one-to-one correspondence; the input end of the power supply switching module is connected to each voltage protection module, and the output end of the power supply switching module is configured to connect with the functional module of the ranging device; the power supply switching module is configured to achieve the electric circuits' “on” and “off” between power supply units and the functional module.

### CROSS-REFERENCE TO RELATED APPLICATIONS

The present disclosure claims priority of the Chinese Patent application No. 2024217846454 entitled “POWER SUPPLY CIRCUIT AND RANGING DEVICE” filed on Jul. 25, 2024, to the China National Intellectual Property Administration, the entire contents of which are incorporated herein by reference.

### FIELD

The present disclosure relates to the technical field of ranging technology, and in particularly to a power supply circuit and a ranging device.

### BACKGROUND

At present, with the development of ranging technology, the functions of ranging devices such as laser range finders have become more and more diversified. As an important component of ranging devices, the power supply circuit is required to provide more electrical energy support for ranging devices. However, traditional ranging devices typically use dry batteries for power supply, which has a problem of insufficient power supply, resulting in insufficient battery life of ranging devices. Therefore, how to improve the battery life of ranging devices has become an urgent problem to be solved.

### SUMMARY

The main purpose of this application is to provide a power supply circuit with multiple power supply units, the power supply circuit can supply sufficient power to ranging devices, and supply power by switching power supply units, thereby improving the battery life of ranging devices.

In one aspect, this application provides a power supply circuit, the power supply circuit is configured to supply power to a functional module of a ranging device; the power supply circuit includes multiple power supply units, multiple voltage protection modules and a power supply switching module; Each voltage protection module is connected to each power supply unit in one-to-one correspondence, the voltage protection module is configured to provide voltage protection; The input end of the power supply switching module is connected to each voltage protection module, and the output end of the power supply switching module is configured to connect with the functional module; the power supply switching module is configured to control the electric circuit's “on” and “off” between the power supply unit and the functional module, thereby switching the power supply unit to supply power to the functional module.

In another aspect, this application also provides a ranging device, the ranging device includes a functional module; and any one of the power supply circuits described in the embodiments, the power supply circuit is configured to supply power to the functional module.

### BRIEF DESCRIPTION OF THE DRAWINGS

The following will briefly introduce the drawings used in the description of the embodiments or the existing technology. Apparently, the drawings in the following description are some embodiments of the present disclosure. For those of ordinary skill in the art, without making any creative efforts, other drawings can be obtained based on these drawings.

FIG. 1 is a circuit diagram of a power supply circuit provided in an embodiment of this application;

FIG. 2 is a circuit diagram of a power supply circuit provided in another embodiment of this application;

FIG. 3 is a circuit diagram of a power supply circuit provided in another embodiment of this application;

FIG. 4 is a circuit diagram of a power supply circuit provided in another embodiment of this application;

FIG. 5 is a circuit diagram of a power supply circuit provided in another embodiment of this application;

FIG. 6 is a circuit diagram of a power supply circuit provided in another embodiment of this application;

FIG. 7 is a circuit diagram of a power supply circuit provided in yet another embodiment of this application;

FIG. 8 is a circuit diagram of a power supply circuit provided in yet another embodiment of this application;

FIG. 9 is a circuit diagram of a power supply circuit provided in yet another embodiment of this application;

FIG. 10 is a circuit diagram of a power supply circuit provided in yet another embodiment of this application;

FIG. 11 is a block diagram of a ranging device provided in an embodiment of this application;

FIG. 12 is a structure diagram of a telescopic optical system provided in an embodiment of this application; and

FIG. 13 is a structure diagram of the housing of a telescopic optical system provided in an embodiment of this application.

### DETAILED DESCRIPTION

The technical solution of embodiments of the present disclosure is described in detail in connection with the accompanying drawings. Described embodiments are some embodiments of the present disclosure, not all embodiments. Based on embodiments of the present disclosure, all other embodiments obtained by those of ordinary skill in the art without creative efforts are within the scope of the present disclosure.

It should be noted that a “connection” in the embodiments of this application refers to an electric connection, and a connection between two electrical elements may be a direct or indirect connection. For example, a connection between A and B may represent that A and B are directly connected to each other, or A and B are indirectly connected to each other by using one or more other electrical elements. For example, the connection between A and B may also represent that A is directly connected to C, C is directly connected to B, and A and B are connected to each other through C.

It should be noted that in no conflicting situations, the embodiments and features within the embodiments described below can be combined with each other.

Please refer to FIG. 1, FIG. 1 is a circuit diagram of a power supply circuit provided in an embodiment of this application. The power supply circuit 100 can be applied to ranging devices. The ranging device can be a range finder, a ranging telescope, etc. The ranging device can include, but is not limited to, a functional module 10 such as a laser emission module, a laser detection module, a data operation and processing module, a human-computer interaction module, a communication module, etc. The functional module 10 can also be a power-consuming module or a power-using module in the ranging device, thereby supporting the ranging device to achieve the relevant ranging functions. The power supply circuit 100 is configured to supply power to the functional module 10 in the ranging device.

As shown in FIG. 1, the power supply circuit 100 includes multiple power supply units 110, multiple voltage protection modules 120 and a power supply switching module 130.

Wherein the number of the power supply units 110 is at least two, the number of the voltage protection modules 120 is the same as that of the power supply units 110. The power supply units 110 can include one or more electric energy storage units, for example, the electric energy storage unit could be one or more batteries. Each power supply unit 110 could be of different types of batteries, for example, multiple power supply units 110 can include at least one rechargeable battery and at least one disposable battery. The power supply unit 110 can be a single battery cell or composed of multiple battery cells in series or parallel.

Each voltage protection module 120 is connected to each power supply unit 110 in one-to-one correspondence, the voltage protection module 120 is configured to provide voltage protection. Wherein voltage protection can be over-voltage protection or under-voltage protection, of course, voltage protection can also include over-voltage protection and under-voltage protection. This way in which each power supply unit 110 is connected to each voltage protection module 120 in one-to-one correspondence can provide better protection for the components in the ranging device, thereby improving the service life and reliability of the ranging device.

The input end of the power supply switching module 130 is connected to each voltage protection module 120, the output end of the power supply switching module 130 is configured to connect with the functional module 10. The power supply switching module 130 is configured to control the electric circuit's “on” and “off” between the power supply unit 110 and the functional module 10, thereby switching the power supply unit 110 to supply power to the functional module 10 of the ranging device.

It should be noted that the power supply switching module 130 can control the electric circuits' “on” and “off” between each power supply unit 110 and the functional module 10, thereby switching the power supply unit 110 that supplies power to the functional module 10. When each power supply unit 110 is different types of batteries, the number of power supply units 110 that supply power to the functional module 10 simultaneously can be one, thereby avoiding the joint power supply of the power supply units 110 with different working voltages.

In the embodiment of this application, the power supply circuit 100 is provided with multiple power supply units 110, and switches multiple power supply units 110 by the power supply switching module 130 for power supply. Therefore, the power supply circuit 100 can provide a sufficient power supply amount for the ranging device, greatly improving the battery life of the ranging device, and thereby being able to enhance the ranging duration and ranging reliability of the ranging device.

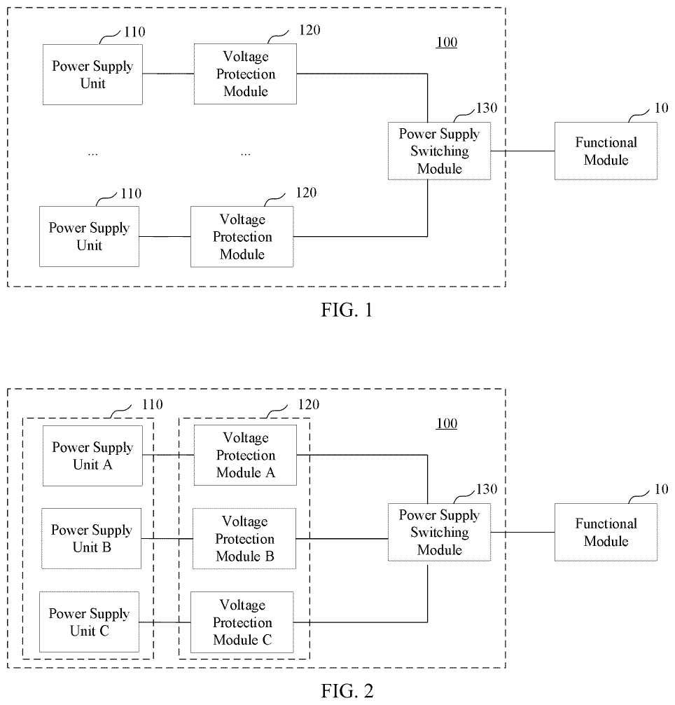

For example, as shown in FIG. 2, multiple power supply units 110 include a power supply unit A, a power supply unit B and a power supply unit C. Wherein the power supply unit A is a disposable battery, the power supply unit B is a rechargeable battery, the power supply unit C is a disposable battery, the battery model of the power supply unit A and power supply unit C can be different. Multiple voltage protection modules 120 include a voltage protection module A, a voltage protection module B and a voltage protection module C. The input ends of the voltage protection module A, voltage protection module B and voltage protection module C respectively are connected to the power supply unit A, power supply unit B and power supply unit C, the output ends of the voltage protection module A, voltage protection module B and voltage protection module C are all connected to the power supply switching module 130. The specific circuit structures of the voltage protection module A, voltage protection module B and voltage protection module C can be the same or different.

As shown in FIG. 2, supposing at the first moment, the power supply switching module 130 controls the electric circuit between the power supply unit A and the functional module 10 to be conducting, and the electric circuits between the power supply units B and C and the functional module 10 to be disconnected, that is, the power supply unit A supplies power to the functional module 10. At the second moment, for switching the power supply unit A that supplies power to the functional module 10 to the power supply unit B, the power supply switching module 130 disconnects the electric circuit between the power supply unit A and the functional module 10, and conducts the electric circuit between the power supply unit B and the functional module 10. The electric circuit between the power supply unit C and the functional module 10 remains disconnected. Obviously, switching the power supply among each power supply unit 110 is realized by the power supply switching module 130, which can provide a sufficient power supply amount for the ranging device, thereby greatly improving the battery life of the ranging device.

In an embodiment, the voltage protection module 120 includes an over-voltage protection unit, the over-voltage protection unit is connected to the power supply unit 110 in one-to-one correspondence, the over-voltage protection unit is configured to provide over-voltage protection, preventing the output voltage of the power supply unit 110 from over-voltage which could cause harm to the safety of the subsequent circuits. For example, the over-voltage protection unit disconnects when the output voltage of the corresponding connected power supply unit 110 is greater than a set over-voltage protection voltage, thereby disconnecting the electric circuit between the power supply unit 110 and the subsequent circuits, the subsequent circuits, for example, are the functional module 10 of the ranging device.

It should be noted that, during the installation or disassembly of each power supply unit 110 in the ranging device, voltage fluctuations often occur, which resulting in an excessively high output voltage of the power supply unit 110. Therefore, this way in which each power supply unit 110 is connected to an over-voltage protection unit in one-to-one correspondence can provide better voltage protection for the components in the ranging device, thereby improving the service life and reliability of the ranging device.

In an embodiment, the voltage protection module 120 includes an under-voltage protection unit, the under-voltage protection unit is connected to the power supply unit 110 in one-to-one correspondence, the under-voltage protection unit is configured to provide under-voltage protection, thereby preventing the power supply unit 110 from over-discharging. For example, the under-voltage protection unit disconnects when the output voltage of the corresponding connected power supply unit 110 is less than or equal to a set under-voltage protection voltage, thereby disconnecting the electric circuit between the power supply unit 110 and the subsequent circuits, avoiding damage to the power supply unit 110 due to over-discharge.

In an embodiment, the voltage protection module 120 includes an over-voltage and under-voltage protection unit, the over-voltage and under-voltage protection unit is connected to the power supply unit 110 in one-to-one correspondence, the over-voltage and under-voltage protection unit is configured to provide over-voltage protection and under-voltage protection. For example, the over-voltage and under-voltage protection unit disconnects when the output voltage of the corresponding connected power supply unit 110 is greater than the set over-voltage protection voltage, and also disconnects when the output voltage of the corresponding connected power supply unit 110 is less than or equal to the set under-voltage protection voltage.

It can be understood that the specific circuit structures of the over-voltage protection unit, the under-voltage protection unit and the over-voltage and under-voltage protection unit in the voltage protection module 120 can be set according to the actual situation, the voltage protection module 120 can also include an over-current protection unit, etc., which is not specifically limited in the embodiment of this application. In some cases, multiple power supply units 110 include rechargeable batteries and disposable batteries, it is required to set a voltage protection module 120 to connect to the output end of the power supply unit 110, thereby providing over-voltage protection or under-voltage protection, avoiding damage to the power supply circuit 100 or the functional module 10, thereby improving the service life and reliability of the ranging device.

In an embodiment, the power supply switching module 130 includes a first switch unit, the input end of the first switch unit is connected to each voltage protection module 120, the output end of the first switch unit is connected to the functional module 10 of the ranging device. The first switch unit can include one or more switch components such as single pole double throw switches, single pole multi-throw switches, relays, transistors or MOSFETs (Metal-Oxide-Semiconductor Field-Effect Transistor), etc.

It should be noted that users can control the first switch unit to switch the power supply unit 110. For example, users can control the first switch unit through triggering operations of triggers in the human-computer interaction module, wherein the triggers include keys, buttons, controls, icons, etc., display screens, for example, are Liquid Crystal Displays (LCDs), Organic Light-Emitting Diode (OLED) displays, etc.

In some examples, the power supply circuit 100 can also be automatically controlled under a set program, thereby switching the power supply unit 110 which supplies power to the functional module 10 in the ranging device. In some cases, the power supply unit 110 which supplies power to the functional module 10 in the ranging device is only one, therefore, when switching power supply units 110, only one power supply unit 110 is switched to another power supply unit 110.

In an embodiment, the power supply switching module 130 includes multiple second switch units, the input end of each second switch unit is connected to each voltage protection module 120 in one-to-one correspondence. The output end of each second switch unit is configured to connect with the functional module 10 in the ranging device. When the second switch unit is conducting, the electric circuit between the corresponding connected power supply unit 110 and the functional module 10 is conducting; When the second switch unit is disconnecting, the electric circuit between the corresponding connected power supply unit 110 and the functional module 10 is disconnecting.

In some cases, among multiple second switch units, only one second switch unit is conducting, the others are all disconnecting, thereby ensuring that only one power supply unit 110 supplies power to the functional module 10 in the ranging device, avoiding safety issues such as circuit faults and damage, etc., which are caused by power supply units 110 with different working parameters participating in power supply together.

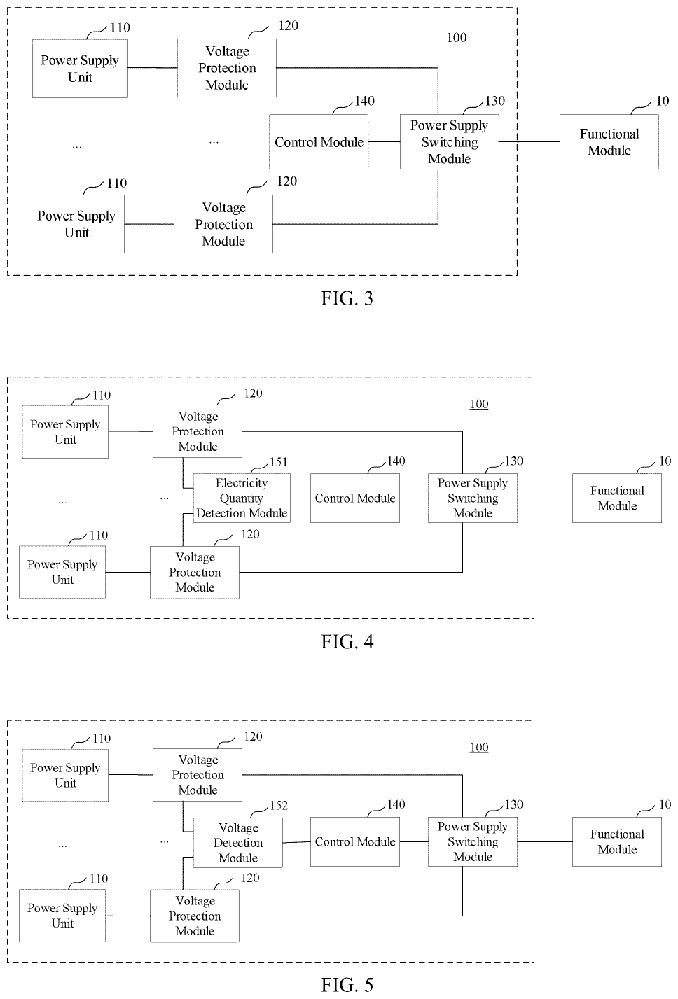

In an embodiment, as shown in FIG. 3, the power supply circuit 100 also includes a control module 140, the control module 140 is connected to a control end of the power supply switching module 130. The control module 140 is configured to control the power supply switching module 130, thereby controlling to switch the power supply unit 110 to supply power to the functional module 10 of the ranging device.

For example, the control module 140 can output a switching instruction to the power supply switching module 130, the switching instruction is configured to instruct the power supply switching module 130 to conduct or disconnect the electric circuits between each power supply unit 110 and the functional module 10, thereby switching the power supply unit 110 that supplies power to the functional module 10 of the ranging device.

In an embodiment, as shown in FIG. 4, the power supply circuit 100 also includes an electricity quantity detection module 151, the input end of the electricity quantity detection module 151 is connected to multiple voltage protection modules 120, the output end of the electricity quantity detection module 151 is connected to the control module 140. The electricity quantity detection module 151 is configured to determine the remaining power of each power supply unit 110 through the output voltage of each voltage protection module 120. The control module 140 is configured to control the power supply switching module 130 according to the remaining power of each power supply unit 110.

The electricity quantity detection module 151 can include one or more microcoulomb detector, current transformer, electricity quantity detection chip, etc. For example, multiple electricity quantity detection chips can be set to be respectively connected to each power supply unit 110, and output the remaining power of each power supply unit 110 to the control module 140. In some cases, the electricity quantity detection module 151 can also calculate the remaining power of the battery by measuring the temperature change of the battery or calculating the energy change during the charging and discharging process.

It should be noted that, after receiving the remaining power of each power supply unit 110, the control module 140 can control the power supply switching module 130 according to the actual situation, thereby realizing the switching of each power supply unit 110.

For example, when the ranging device is on, the control module 140 can determine a target power supply unit corresponding to the maximum remaining power from the remaining power of each power supply unit 110, and control the power supply switching module 130 to switch the target power supply unit to supply power.

For example, when the remaining power of the power supply unit 110 currently supplying power is less than or equal to a set remaining power, the control module 140 also can determine at least one target power supply unit from the other power supply units 110 that has a remaining power greater than the set remaining power, and select one target power supply unit from at least one target power supply unit, and control the power supply switching module 130 to switch the selected target power supply unit to supply power.

It should be noted that through the electricity quantity detection module 151 detects the remaining power of each power supply unit 110, and through the control module 140 controls the power supply switching module 130 according to the remaining power of each power supply unit 110, thereby flexibly switching the power supply unit 110 to supply power to the functional module 10 in ranging device according to the actual situation, which can provide a sufficient power supply amount for the ranging device without the need for frequent battery replacement, and greatly improve the battery life of the ranging device.

In an embodiment, as shown in FIG. 5, the power supply circuit 100 also includes a voltage detection module 152, the input end of the voltage detection module 152 is connected to multiple voltage protection modules 120, the output end of the voltage detection module 152 is connected to the control module 140. The voltage detection module 152 is configured to detect the output voltage of each voltage protection module 120. The control module 140 is configured to control the power supply switching module 130 according to the output voltage of each voltage protection module 120.

It should be noted that the specific circuit structure of the voltage detection module 152 can be set according to the actual situation, for example, the bipolar junction transistor can be configured to control the conducting and disconnecting of the voltage protection module 120, when the voltage is normal, the bipolar junction transistor conducts, thus making the voltage protection module 120 conductive, when the voltage is under-voltage or over-voltage, the bipolar junction transistor disconnects, thus making the voltage protection module 120 open-circuit. The output voltage of the voltage protection module 120 can represent the output voltage of the power supply unit 110, the control module 140 can determine the power condition of the power supply unit 110 by continuously detecting the output voltage of the voltage protection module 120, thus controlling the power supply switching module 130 to switch an appropriate power supply unit 110 to supply power to the functional module 10 of the ranging device.

For example, the control module 140 can include a battery management chip, the battery management chip can determine the remaining power of the power supply unit 110 according to the relevant values of the output voltage of the power supply unit 110, thereby realizing the control of the power supply switching module 130, specifically, please refer to the relevant examples of the electricity quantity detection module 151 mentioned above, this embodiment of this application does not repeat.

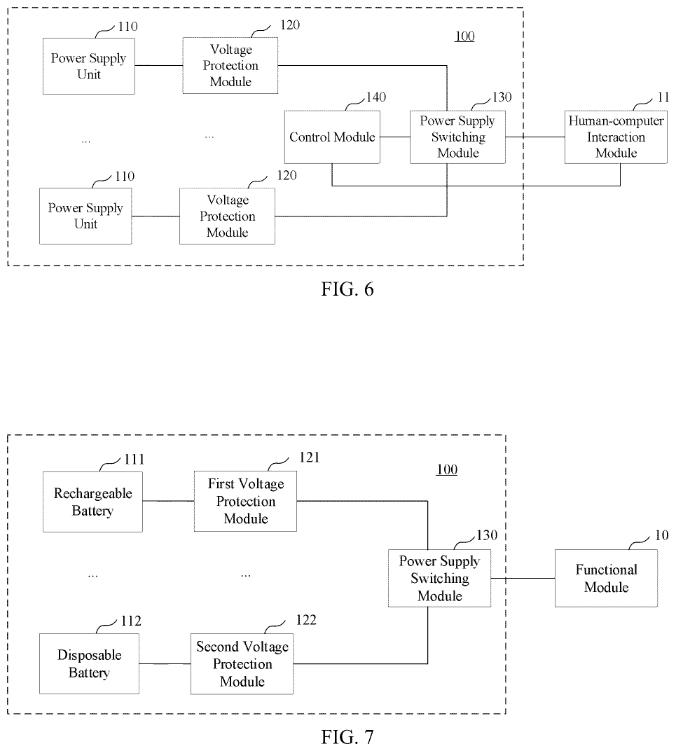

In an embodiment, as shown in FIG. 6, the functional module 10 includes a human- computer interaction module 11, the control module 140 is also connected to the human- computer interaction module 11. The human-computer interaction module 11 generates a corresponding power switching instruction based on the user's touch operation. The control module 140 is configured to control the power supply switching module 130 according to the power switching instruction output by the human-computer interaction module 11.

The human-computer interaction module 11 can include keys, display screens, etc., Users can perform touch operations on the human-computer interaction module 11 to enter a control interface, and to generate a corresponding control instruction based on the control interface. For example, the control interface can be a power selection interface, and the control instruction can be the power switching instruction, the power switching instruction is configured to instruct the selection of a target power supply unit from multiple power supply units 110 to supply power.

It should be noted that, after receiving the power switching instruction output by the human-computer interaction module 11, the control module 140 controls the power supply switching module 130 based on the power switching instruction. For example, the control module 140 can generate a first switching instruction based on the power switching instruction, the first switching instruction is configured to instruct the power supply switching module 130 to disconnect the electric circuits between the other power supply units 110 except the target power supply unit and the functional module 10, and to conduct the electric circuit between the target power supply unit and the functional module 10, thereby switching the target power supply unit to supply power to the functional module 10 of the ranging device.

In an embodiment, the control module 140 includes a control chip. After the ranging device is on or the switched power supply unit 110 supplies power, the control chip is configured to control the human-computer interaction module 11 to output an identification information of the power supply unit 110 currently supplying power.

The identification information of the power supply unit 110 is configured to identify the power supply unit 110. The identification information can include one or a combination of patterns, letters, words, and numbers. After the ranging device is on or the switched power supply unit 110 supplies power, the control chip can determine the power supply unit 110 currently supplying power. Therefore, the control chip can control the human-computer interaction module 11 to make the human-computer interaction module 11 output the identification information of the power supply unit 110 currently supplying power, thereby informing users of the currently used power supply unit 110.

For example, when the remaining power of the selected target power supply unit is less than or equal to the set remaining power, it needs to switch the other power supply units to supply power. When switching the other power supply units to supply power, the control chip in the control module 140 can output a power supply instruction to the human-computer interaction module 11, the power supply instruction is configured to instruct the human-computer interaction module 11 to output a power supply information, the power supply information includes the identification information of the power supply unit 110 currently supplying power.

In an embodiment, the human-computer interaction module 11 can also generate a power priority switching instruction based on user's touch operations, the power priority switching instruction is configured to instruct that the target power supply unit among multiple power supply units 110 is used as a priority power supply unit for power supply; when selecting the power supply unit 110, the control module 140 is configured to preferentially select the target power supply unit for power supply according to the power priority switching instruction. For example, when the ranging device is on, the control module 140 preferentially selects the target power supply unit for power supply. Or, when switching the power supply unit 110, the control module 140 preferentially selects the target power supply unit for power supply.

In an embodiment, the control module 140 is also configured to generate a power usage information of the power supply unit 110, the human-computer interaction module 11 is configured to output the power usage information, the power usage information is configured to instruct the currently used power supply unit, thereby informing users which power supply unit is currently used. For example, when the ranging device is on, through the human-computer interaction module 11 outputs the power usage information, the power usage information can be displayed.

In an embodiment, the control module 140 is also configured to generate a power switching information of the power supply unit 110, the human-computer interaction module 11 is configured to output the power switching information, the power switching information is configured to instruct that a switch in the power supply units 110 has occurred. For example, when the power capacity of a power supply unit 110 is less than a set power capacity, the control module 140 generates the power switching instruction to control the power supply switching module 130 to switch the electric circuit. The control module 140 also sends the power switching instruction to the human-computer interaction module 11, and the human-computer interaction module 11 outputs the power switching information based on the power switching instruction.

In an embodiment, as shown in FIG. 7, multiple power supply units 110 include at least one rechargeable battery 111 and at least one disposable battery 112. The rechargeable battery 111 can include a rechargeable lithium-ion battery, and the disposable battery 112 can include a button battery such as a CR2 battery. By using the rechargeable battery 111 and the disposable battery 112, a dual-battery core concept is provided to users, thereby offering them a more intelligent power usage strategy and method.

The control module 140 can be configured to control the power supply switching module 130 to make the rechargeable battery 111 supply power to the functional module 10 when the remaining power of the rechargeable battery 111 is greater than or equal to a first remaining power threshold and an external power source is not connected. The control module 140 can also be configured to control the power supply switching module 130 to make the disposable battery 112 supply power to the functional module 10 when the remaining power of the rechargeable battery 111 is less than or equal to a second remaining power threshold and the external power source is not connected.

It should be noted that the first remaining power threshold can be greater than or equal to the second remaining power threshold, The specific values of the first remaining power threshold and the second remaining power threshold can be set according to the actual situation. For example, the first remaining power threshold can be set to 50%, and the second remaining power threshold can be set to 10%. As it should be, the first remaining power threshold and the second remaining power threshold can both be set to 10%. When the external power source is not connected, it means that the external power source is not connected to the power supply circuit 100, or it also means that the external power source is not connected to a charging interface of the ranging device. The external power source can be configured to charge the rechargeable battery 111, or supply power to the functional module 10.

It should be noted that, in most cases, users can select the rechargeable battery 111 for power supply. In extreme cases, for example, in the outdoor environment, since there are no charging conditions, the disposable battery 112 can be used for power supply. In normal cases, users can choose not to install the disposable battery 112, such as the CR2 battery. Only when the power of the rechargeable battery 111 runs out and there are no charging conditions, the disposable battery 112 can be used.

As it should be, some users do not like charging, it is okay to keep using the disposable battery 112. In some environment, you can also install only the rechargeable battery 111 or the disposable battery 112 based on actual needs, and it is not necessary to have both sets of power supply units installed all the time.

In an embodiment, as shown in FIGS. 7 to 10, the voltage protection module 120 can include a first voltage protection module 121 and a second voltage protection module 122. The first voltage protection module 121 is connected between the rechargeable battery 111 and the power supply switching module 130, the second voltage protection module 122 is connected between the disposable battery 112 and the power supply switching module 130. The specific circuit structures of the first voltage protection module 121 and second voltage protection module 122 can be set according to the actual situation. In the case where multiple power supply units 110 include the rechargeable battery 111 and the disposable battery 112, the specific circuit structures of the first voltage protection module 121 and second voltage protection module 122 can be different.

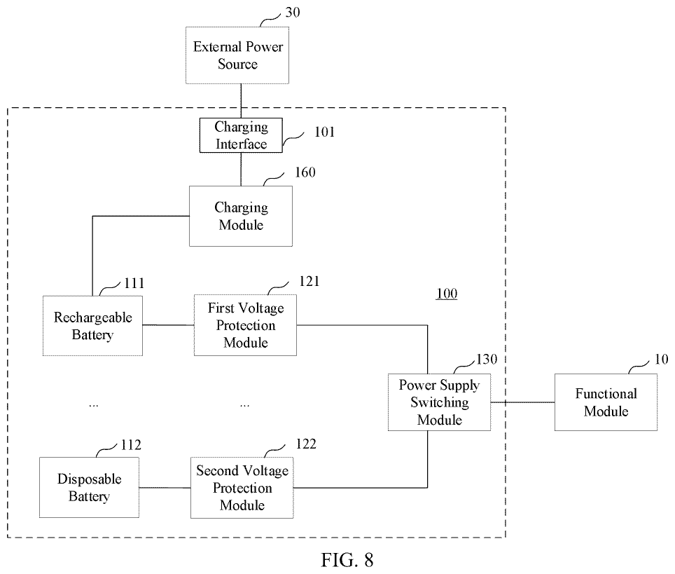

In an embodiment, as shown in FIGS. 8 to 10, the power supply circuit 100 also includes a charging module 160, the input end of the charging module 160 is configured to connect with the charging interface 101, the charging interface 101 is configured to connect with the external power source 30, the output end of the charging module 160 is connected to the rechargeable battery 111.

The charging interface 101 can be a USB charging interface, such as a Type-C interface, as it should be, it can also be other types of interfaces. The external power source 30 can be an energy storage device, the energy storage device can include rechargeable batteries or disposable batteries. The external power source 30 can also include power grids, generators, solar cells, etc.

It should be noted that in the case where the power supply unit 110 is the disposable battery 112, it is not necessary to set the charging interface 101 and the charging module 160 for the disposable battery 112. In the case where the power supply unit 110 is the rechargeable battery 111, the rechargeable battery 111 is connected to the external power source 30 through the charging interface 101, and the external power source 30 can charge the rechargeable battery 111 through the charging module 160, thereby ensuring that the rechargeable battery 111's power supply can be replenished without the need for frequent battery replacement, and improving the battery life of the ranging device.

In an embodiment, the charging interface 101 is also connected to the functional module 10 of the ranging device, so when the charging interface 101 is connected to the external power source 30, the external power source 30 can supply power to the functional module 10 of the ranging device.

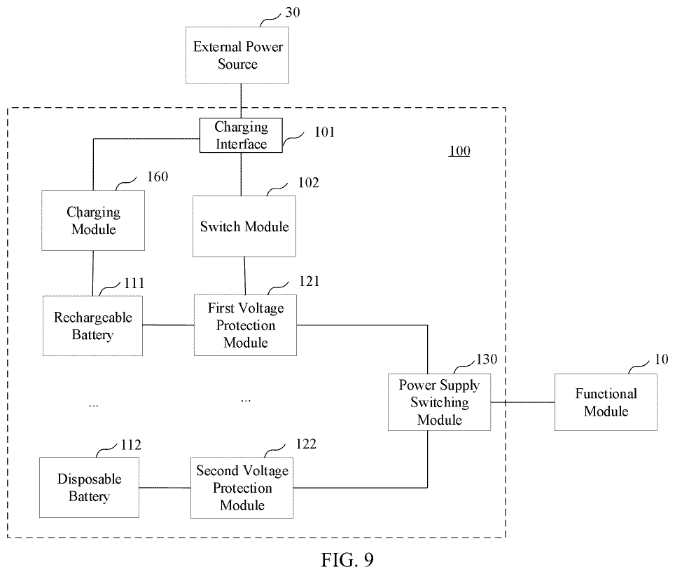

For example, as shown in FIG. 9, the power supply circuit 100 also includes a switch module 102, the first end of the switch module 102 is connected to the charging interface 101, the second end of the switch module 102 is connected to the voltage protection module 120 which is correspondingly connected to the rechargeable battery 111. When the charging interface 101 is not connected to the external power source 30, the switch module 102 is off to avoid the voltage loss of the rechargeable battery 111. When the charging interface 101 is connected to the external power source 30, the switch module 102 is on, thereby conducting the electric circuit from the external power source 30 to the functional module 10, and enabling the external power source 30 to supply power to the functional module 10 of the ranging device.

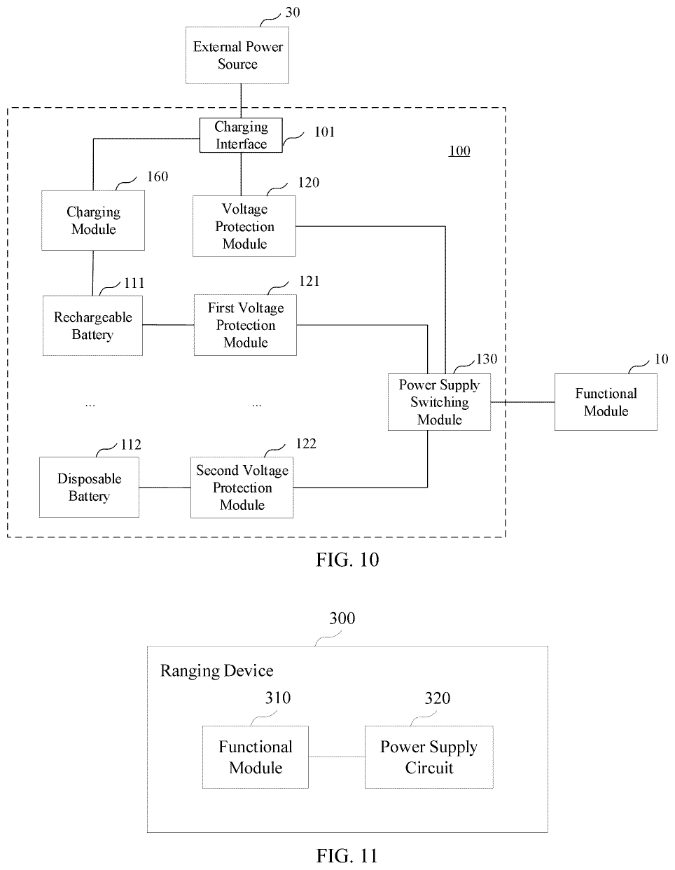

For example, as shown in FIG. 10, the power supply circuit 100 also includes the voltage protection module 120 connected to the charging interface 101, the voltage protection module 120 is also connected to the power supply switching module 130. When the charging interface 101 is connected to the external power source 30, the power supply switching module 130 can conduct the electric circuit from the external power source 30 to the functional module 10, and disconnect the electric circuits from each power supply unit 110 to the functional module 10, thereby enabling the external power source 30 to supply power to the functional module 10 of the ranging device to reduce the power consumption of each power supply unit 110.

In the aforementioned embodiments, the power supply circuit 100 includes multiple power supply units 110, multiple voltage protection modules 120 and a power supply switching module 130, each voltage protection module 120 is connected to each power supply unit 110 in one-to-one correspondence, the voltage protection module 120 is configured to provide voltage protection. The input end of the power supply switching module 130 is connected to each voltage protection module 120, the output end of the power supply switching module 130 is configured to connect with the functional module 10 of the ranging device; The power supply switching module 130 is configured to control the electric circuits' “on” and “off” between each power supply unit 110 and the functional module 10, thereby switching power supply units 110 to supply power to the functional module 10 of the ranging device. By using multiple power supply units 110 to supply power to the functional module 10 of the ranging device, and switching among multiple power supply units 110 for power supply, which can provide a sufficient power supply amount for the ranging device without the need for frequent battery replacement, and greatly improve the battery life of the ranging device.

Please refer to FIG. 11, FIG. 11 is a block diagram of a ranging device provided in an embodiment of this application.

As shown in FIG. 11, a ranging device includes a functional module 310 and a power supply circuit 320, the power supply circuit 320 is configured to supply power to the functional module 310.

Wherein the functional module 310 can be one or more, the power supply circuit 320 can supply power to one or more functional module 310.

For example, the functional module 310 can include a laser emission module, a laser detection module, a data operation and processing module, a human-computer interaction module, a communication module, etc. The functional module 310 can be configured to realize the ranging function. It should be noted that the functional module 310 can be the functional module 10 in the aforementioned embodiments.

For example, the power supply circuit 320 includes multiple power supply unit, the power supply unit can include one or more electric energy storage units, the electric energy storage unit, for example, can be one or more batteries. The power supply unit can be composed of multiple batteries in series or parallel. It should be noted that the power supply circuit 320 can be the power supply circuit 100 in the aforementioned embodiments.

In an embodiment, the ranging device 300 can be a range finder, a ranging telescope, etc. When the ranging device 300 is a ranging telescope, the functional module of the ranging device 300 can also include a telescopic optical system, the telescopic optical system can include an objective lens assembly, an eyepiece assembly and a housing assembly. In some examples, the telescopic optical system can also include a prism assembly or a lens steering system.

In an embodiment, the ranging device 300 includes the ranging telescope, the ranging telescope includes the telescopic optical system, the power supply units of the power supply circuit 320 can include at least one rechargeable battery and at least one disposable battery. The ranging telescope also includes a first battery compartment and a second battery compartment arranged within the telescopic optical system.

Wherein the first battery compartment is configured to load the rechargeable battery, and the first battery compartment is placed in the telescopic optical system; the second battery compartment is configured to load the disposable battery, and the cover of the second battery compartment is detachably configured as a part of the housing of the telescopic optical system. Since the rechargeable battery does not need to be detached after installation, it can be placed in any position of the telescopic optical system. Since there is a replacement requirement for the disposable battery, the cover of the second battery compartment is detachably configured as a part of the housing of the telescopic optical system. When it is necessary to replace the disposable battery, the cover of the second battery compartment as a part of the housing of the telescopic optical system can be opened, thereby facilitating the replacement operation of the disposable battery.

It should be noted that due to the low space utilization rate of the telescopic optical system in the ranging telescope, the first battery compartment and the second battery compartment can be placed in the telescopic optical system, thereby the first battery compartment and the second battery compartment, which occupy a larger space in the power supply circuit 320, can be installed in the telescopic optical system, that makes the structural layout more compact and greatly improves the space utilization rate of the ranging telescope.

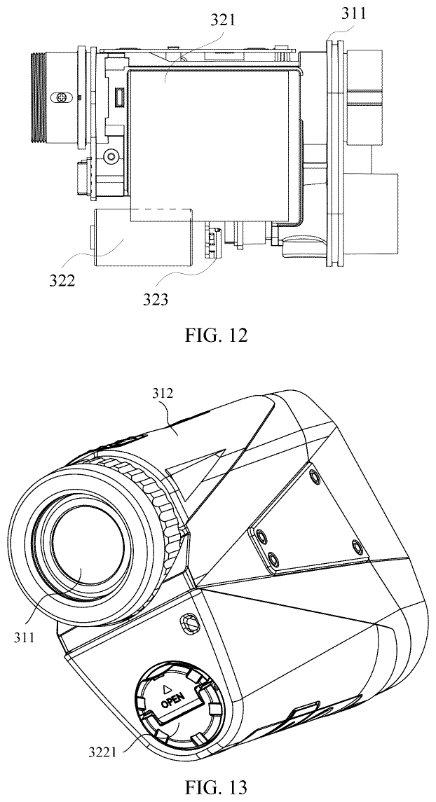

For example, as shown in FIGS. 12 and 13, the ranging telescope includes a telescopic optical system 311, the power supply unit of the power supply circuit 320 includes at least one rechargeable battery and at least one disposable battery. The ranging telescope also includes a first battery compartment 321 and a second battery compartment 322 arranged within the telescopic optical system 311. Wherein the first battery compartment 321 is configured to load the rechargeable battery, and the first battery compartment 321 is placed in the telescopic optical system 311; the second battery compartment 322 is configured to load the disposable battery, and the cover 3221 of the second battery compartment 322 is detachably configured as a part of the housing 312 of the telescopic optical system 311.

In an embodiment, the power supply circuit 320 includes a charging module and a charging interface which are arranged in the telescopic optical system 311; wherein the charging interface is exposed on the housing 312 of the telescopic optical system 311, the charging interface is connected to the first battery compartment 321 through the charging module.

It should be noted that the charging interface is configured to connect with the external power source, the charging interface can be a USB charging interface, such as a Type-C interface. In the case where the first battery compartment is configured to load the rechargeable battery, the rechargeable battery can be connected to the external power source through the charging interface, and the external power source charges the rechargeable battery through the charging module, thereby ensuring that the rechargeable battery's power supply can be replenished, and improving the battery life of the ranging device 300.

For example, as shown in FIGS. 12 and 13, the power supply circuit 320 includes a charging module (not shown in the figure) and a charging interface 323 which are arranged in the telescopic optical system 311. Wherein the charging interface 323 is exposed on the housing 312 of the telescopic optical system 311, the charging interface 323 is connected to the first battery compartment 321 through the charging module.

In the aforementioned embodiments, the ranging device 300 includes the functional module 310 and the power supply circuit 320, wherein the power supply circuit 320 includes the power supply circuit 100 described in the aforementioned embodiments, by using multiple power supply units in the power supply circuit 320 to supply power to the functional module 310 of the ranging device 300, and switching among multiple power supply units for power supply, which can provide a sufficient power supply amount for the ranging device 300 without the need for frequent battery replacement, and greatly improve the battery life of the ranging device 300.

The aforementioned descriptions are merely specific embodiments of this application, but are not intended to limit the protection scope of this application. Any variation or replacement readily figured out by a person skilled in the art within the technical scope disclosed in this application shall fall within the protection scope of this application. Therefore. the protection scope of this application shall be subject to the protection scope of the claims.

What is claimed is:

1. A power supply circuit, configured to supply power to a functional module of a ranging device, comprising:
multiple power supply units;
multiple voltage protection modules, each voltage protection module is connected to each power supply unit in one-to-one correspondence, the voltage protection module is configured to provide voltage protection; and
a power supply switching module, an input end of the power supply switching module is connected to each voltage protection module, an output end of the power supply switching module is configured to connect with the functional module, the power supply switching module is configured to control an electric circuit's “on” and “off” between the power supply unit and the functional module, to switch the power supply unit to supply power to the functional module.

2. The power supply circuit according to claim 1, further comprising:
a control module connected to a control end of the power supply switching module, configured to control the power supply switching module to switch the power supply unit to supply power to the functional module.

3. The power supply circuit according to claim 2, further comprising:
an electricity quantity detection module, an input end of the electricity quantity detection module is connected to multiple voltage protection modules, an output end of the electricity quantity detection module is connected to the control module; the electricity quantity detection module is configured to determine a remaining power of each power supply unit through an output voltage of each voltage protection module;
the control module is configured to control the power supply switching module according to the remaining power of each power supply unit.

4. The power supply circuit according to claim 2, wherein the functional module comprises:
a human-computer interaction module generating a corresponding power switching instruction based on user's touch operation;
the control module is connected to the human-computer interaction module, the control module is configured to control the power supply switching module according to the power switching instruction output by the human-computer interaction module.

5. The power supply circuit according to claim 4, wherein the control module comprises:
a control chip configured to control the human-computer interaction module to output an identification information of the power supply unit currently supplying power after the ranging device is on or the switched power supply unit supplies power.

6. The power supply circuit according to claim 2, wherein the multiple power supply units comprise: at least one rechargeable battery and at least one disposable battery;
the control module is configured to control the power supply switching module to make the rechargeable battery supply power to the functional module when a remaining power of the rechargeable battery is greater than or equal to a first remaining power threshold and an external power source is not connected; or
the control module is configured to control the power supply switching module to make the disposable battery supply power to the functional module when the remaining power of the rechargeable battery is less than or equal to a second remaining power threshold and the external power source is not connected.

7. The power supply circuit according to claim 6, further comprising:
a charging module, an input end of the charging module is configured to connect with a charging interface, the charging interface is configured to connect with the external power source, an output end of the charging module is connected to the rechargeable battery.

8 to 10. (canceled)

11. The power supply circuit according to claim 7, further comprising:
a switch module, a first end of the switch module is connected to the charging interface, a second end of the switch module is connected to the voltage protection module which is correspondingly connected to the rechargeable battery.

12. The power supply circuit according to claim 2, further comprising:
a voltage detection module, an input end of the voltage detection module is connected to multiple voltage protection modules, an output end of the voltage detection module is connected to the control module.

13. A ranging device, comprising:
a functional module; and
a power supply circuit configured to supply power to the functional module, the power supply circuit comprises:
multiple power supply units;
multiple voltage protection modules, each voltage protection module is connected to each power supply unit in one-to-one correspondence, the voltage protection module is configured to provide voltage protection; and
a power supply switching module, an input end of the power supply switching module is connected to each voltage protection module, an output end of the power supply switching module is configured to connect with the functional module, the power supply switching module is configured to control an electric circuit's “on” and “off” between the power supply unit and the functional module, to switch the power supply unit to supply power to the functional module.

14. The ranging device according to claim 13, wherein the power supply circuit further comprises:
a control module connected to a control end of the power supply switching module, configured to control the power supply switching module to switch the power supply unit to supply power to the functional module.

15. The ranging device according to claim 14, wherein the power supply circuit further comprises:
an electricity quantity detection module, an input end of the electricity quantity detection module is connected to multiple voltage protection modules, an output end of the electricity quantity detection module is connected to the control module; the electricity quantity detection module is configured to determine a remaining power of each power supply unit through an output voltage of each voltage protection module;
the control module is configured to control the power supply switching module according to the remaining power of each power supply unit.

16. The ranging device according to claim 14, wherein the functional module comprises:
a human-computer interaction module generating a corresponding power switching instruction based on user's touch operation;
the control module is connected to the human-computer interaction module, the control module is configured to control the power supply switching module according to the power switching instruction output by the human-computer interaction module.

17. The ranging device according to claim 16, wherein the control module comprises:
a control chip configured to control the human-computer interaction module to output an identification information of the power supply unit currently supplying power after the ranging device is on or the switched power supply unit supplies power.

18. The ranging device according to claim 14, wherein the multiple power supply units comprise: at least one rechargeable battery and at least one disposable battery;
the control module is configured to control the power supply switching module to make the rechargeable battery supply power to the functional module when a remaining power of the rechargeable battery is greater than or equal to a first remaining power threshold and an external power source is not connected; or
the control module is configured to control the power supply switching module to make the disposable battery supply power to the functional module when the remaining power of the rechargeable battery is less than or equal to a second remaining power threshold and the external power source is not connected.

19. The ranging device according to claim 18, wherein the power supply circuit further comprises:
a charging module, an input end of the charging module is configured to connect with a charging interface, the charging interface is configured to connect with the external power source, an output end of the charging module is connected to the rechargeable battery.

20. The ranging device according to claim 19, wherein the power supply circuit further comprises:
a switch module, a first end of the switch module is connected to the charging interface, a second end of the switch module is connected to the voltage protection module which is correspondingly connected to the rechargeable battery.

21. The ranging device according to claim 14, wherein the power supply circuit further comprises:
a voltage detection module, an input end of the voltage detection module is connected to multiple voltage protection modules, an output end of the voltage detection module is connected to the control module.

22. The ranging device according to claim 13, wherein the power supply units of the power supply circuit comprise at least one rechargeable battery and at least one disposable battery;
the ranging device comprises:
a ranging telescope comprising a telescopic optical system, a first battery compartment and a second battery compartment, wherein the first battery compartment and the second battery compartment are arranged within the telescopic optical system;
the first battery compartment is configured to load the rechargeable battery and is placed in the telescopic optical system; the second battery compartment is configured to load the disposable battery, and a cover of the second battery compartment is detachably configured as a part of a housing of the telescopic optical system.

23. The ranging device according to claim 22, wherein the power supply circuit comprises: a charging module and a charging interface; wherein the charging module and the charging interface are arranged in the telescopic optical system; the charging interface is exposed on the housing of the telescopic optical system, the charging interface is connected to the first battery compartment through the charging module.
